(19) United States
(12) Patent Application Publication
(10) Pub. No.: US 2006/0281863 A1
(43) Pub. Date: Dec. 14, 2006

(54) Heat releasable wafer dicing tape

(75) Inventors: Wilson Xia, York, PA (US); Deepak Hariharan, York, PA (US); Joel Barton, Wellsville, PA (US)

Correspondence Address: BIRCH STEWART KOLASCH & BIRCH, PO BOX 747, FALLS CHURCH, VA, 22040-0747, US

(73) Assignee: ADHESIVES RESEARCH, INC., Glen Rock, PA (US)

(21) Appl. No.: 10/560,828

(22) PCT Filed: Nov. 17, 2003
(86) PCT No.: PCT/US03/36559

§ 371 Date: Jun. 12, 2006

Related U.S. Application Data
(60) Provisional application No. 60/479,179, filed on Jun. 18, 2003.

(51) Int. Cl. C08F 8/30; C08F 8/42

(52) U.S. Cl. 525/126; 525/360; 525/374; 525/375

(57) ABSTRACT

A thermocurable pressure sensitive adhesive composition is provided comprised of at least one pressure sensitive adhesive, at least one multifunctional monomer or oligomer, at least one free radical initiator, and optionally a crosslinking agent. The pressure sensitive adhesive composition of the present invention may be used with advantage in the production of a semiconductor chip, wherein a wafer chip is attached to the pressure sensitive adhesive layer during the chip manufacturing process during which a diced chip is produced. The adhesive composition may be thermocured once the diced chip has been processed to permit ease of removal of the diced chip due to loss of adhesion by the adhesive composition as a result of being thermocured.

The present invention is directed to a novel pressure sensitive adhesive tape that can be used in the production of semiconductor chips. The tape serves as a dicing tape for holding wafers securely in position during the dicing and cleaning process. The adhesion can be greatly reduced by the application of heat, thereby allowing the diced chips to be easily released.

Semiconductor wafers are generally produced in relatively large dimension such as large diameter disks. The wafers are subsequently diced and cut into chips of much smaller size for use in the production of integrated circuits. Such wafers are generally made of silicon, gallium-arsenide, or similarly suitable material, and are extremely delicate by nature due both to the material employed and the fact that the wafer is very thin. The wafer is thus susceptible to breakage if unduly stressed during the manufacturing process or during the die cutting step to produce the chips.

The semiconductor wafer is adhesively bonded to a backing sheet during the dicing step. Once the wafer is pattern diced to produce a multitude of chips, each chip must be removed from the backing sheet for further processing. Generally, adhesives such as acrylate adhesives are used to bond the semiconductor wafer to the backing sheet. Such adhesives have been found to be unacceptable for several reasons. First, the adhesives exhibit excessive adhesion with respect to the attached semiconductor wafer. Excessive adhesion is a disadvantage during the removal of the diced chips as the chip tends to resist separation from the backing sheet resulting in cracking of the fragile chips. Even if successfully removed from the backing layer, the diced chips are subject to contamination by any adhesive residue which remains attached to the back of the chip. Given the need for non-contaminated chips, such adhesive contamination is unacceptable and a potential cause for rejection of the chip.

Several solutions have been proposed for this problem. The adhesive layer has been irradiated with UV radiation while in contact with the wafer and subsequent to the dicing step to reduce adhesion of the adhesive layer to the diced wafer. Alternatively, in an attempt to lower the overall adhesive value of the adhesive layer attached to the wafer, it has been proposed to employ a backing sheet which contains a layer of the adhesive which has been pattern-cured by UV radiation. However, pattern curing is a less than acceptable solution in that the uncured portion of the adhesive layer may contaminate the semiconductor wafer and/or still resist removal of the chip depending upon the size of the chip and the area of the non-pattern-cured portion of the adhesive in contact with the chip.

It has also been found that conventional acrylate adhesives may exhibit undesirable buildup of adhesion over time. This enhances the inability of the diced chip (upon long-term contact with the backing sheet) to be successfully removed from the backing sheet.

Prior U.S. Pat. Nos. 4,720,317; 4,756,968; 4,818,621; 4,983,960; 4,968,559; 4,999,242; 5,149,586; 5,187,007; 5,281,473; and 5,304,418 are each directed to semiconductor wafer dicing and to the above attempts to address prior art problems but which are believed unsatisfactory for the reasons noted above.

The present invention is directed to the use of a pressure sensitive adhesive tape which is designed to exhibit the temporary bonding desirable for use in the semiconductor wafer dicing process. The adhesion level can be tailored to provide sufficient bonding strength so that the wafer can be securely held in position during dicing and cleaning of the chip. Typical adhesion levels of such tapes as characterized by 180° peel on stainless steel (ASTM D3330/D3330M-02 or PSTC Method 101) can range as low as but not limited to 0.5 oz/in, and as high as, but not limited to, 90 oz/in. When the pressure sensitive tape of the present invention is subjected to an elevated temperature of at least 50° C. (for a period of time, for example, of at least one second), the adhesive becomes detackified and loses its pressure sensitive adhesive properties. Upon heat treatment, the typical peel adhesion of the tape can be decreased sufficiently low to permit removal of the diced chip from the tape. The detackification of the adhesive is irreversible.

The pressure sensitive adhesive tape of the present invention is typically comprised of a backing film, a pressure sensitive adhesive layer and a release liner to protect the adhesive coating. The backing film is typically a polymeric material, or a blend of polymeric materials. Such materials include but are not limited to polyethylene, polypropylene, polyvinyl chloride, polyvinylidene chloride, polyester, polyamide, polyurethane, polyether, polycarbonate, polysolfone, polyketone, polyetherketone, polyimide, copolymers of styrene-diene, copolymer of butylene terephthalate-ether, and natural or synthetic rubbers. Alternative backing materials that can be used include foam, metal foil, and paper. Expandable films which exhibit good heat resistance are preferred. The backing film generally has a thickness of from 0.1 to 5 mils, preferably from 0.5 to 1.0 mil.

The pressure sensitive adhesive of the present invention is comprised of a pressure sensitive adhesive, at least one multifunctional monomeric or oligomeric component, at least one free radical initiator, and optionally, a crosslinking agent.

The pressure sensitive adhesive or adhesive blend may comprise, for example, tackified natural rubbers, synthetic rubbers, tackified styrene block copolymers, polyvinyl ethers, acrylic adhesives, poly-alpha-olefins and silicone adhesives, as well as blends thereof. Among them, acrylic adhesives with functional groups are particularly preferred. Examples of such adhesives are polymers or copolymers of acrylic acid, t-butylmethacrylate, butyl acrylate, 2-ethylhexylacrylate, glycidyl methacrylate, hydroxyethylacrylate, N-methylol acrylamide, N-methylol acrylamide, isobornyl methacrylate, N-vinylpyrrolidone and vinyl acetate.

The multifunctional vinyl monomeric or oligomeric component includes but is not limited to vinyl ethers, styrenic monomers, diene monomers, acrylates and methacrylates.

Exemplary multifunctional monomers include but are not limited to ethylenically unsaturated difunctional monomers such as diacrylate compounds, including 1,6-diacrylates, 1,4-butanediol diacrylate, ethylene glycol diacrylate, diethylene glycol diacrylate, tetraethylene glycol diacrylate, tripropylene glycol diacrylate, neopentyl glycol diacrylates, 1,4-butanediol dimethyacrylate, hexane diol diacrylate, poly(butanediol)diacrylates, tetraethylene glycol dimethacrylate, 1,3-butylene glycol diacrylate, triethylene glycol diacrylate, triisopropylene glycol diacrylate, polyethylene glycol diacrylate, diallyl maleate, dially phthalate, and bisphenol A dimethylacrylate.

Exemplary trifunctional monomers include but are not limited to trimethylolpropane triacrylate, trimethylolpropane trimethyacrylate, pentaerythritol monohydroxy triacrylate, and trimethylolpropane triethoxy triacrylate, ethoxylated trimethylolpropane triacrylate, pentaerythritol triacrylate, etc.

Exemplary tetrafunctional monomers include but are not limited to pentaerythritol tetracrylate and di-trimethylolpropane tetraacrylate.

Exemplary pentafunctional monomers include but are not limited to dipentaerythritol pentaacrylate.

A variety of multifunctional oligomers may be employed. For example, a multifunctional urethane oligomer may be obtained by reacting a terminal isocyanate urethane prepolymer obtained by the reaction of polyester or polyether type polyol compounds, with polyvalent isocyanate compounds. For example, compounds such as 2,4-toluene diisocyanate, 2,6-toluene diisocyanate, 1,4-xylylene diisocyanate, and diphenylmethane 4,4′-diisocyanate may be reacted with 2-hydroxyethyl (meth)acrylate, 2-hydroxypropyl(meth)acrylate, polyethylene glycol (meth)acrylate, etc. Preferably, the molecular weight of the urethane oligomer is at least 3000, and preferably within the range of from 3000 to 10,000.

Additional oligomers which may be employed include but are not limited to polyester acrylates, epoxy acrylates, silicone acrylates, and unsaturated polyesters.

An exemplary urethane oligomer is a difunctional aliphatic urethane acrylate oligomer available from Sartomer Company under the trade designation CN 966H90.

Such multifunctional components are disclosed in U.S. Pat. Nos. 5,420,195 and 5,563,205, each herein incorporated by reference.

The free radical initiator includes but is not limited to azo compounds, peroxides and organic polyoxides.

Optionally, a crosslinking agent may be selected from the group consisting of isocyanates, amines, aziridines, anhydrides, and metal chelates, although this listing is not intended to be all inclusive.

In the pressure sensitive adhesive composition of the present invention, the pressure sensitive adhesive component is generally present in an amount of from 25-90% by weight, the multifunctional component is generally present in an amount of from 5-55% by weight, the free radical initiator is generally present in an amount of from 0.5-10% by weight, and the optional crosslinking agent is generally present in an amount of from 0-5.0% by weight, each based on the total weight of the composition.

The pressure sensitive adhesive tape of the present invention may be produced by coating a solution of the adhesive on the backing material, followed by removal of any solvent present (such as by evaporation or reduced pressure) using a programmed temperature cycle to ensure complete removal of the solvent and retention of the deactivating components in the composition.

During the manufacturing process, once the chip has been die cut, heat is applied to the pressure sensitive adhesive tape to reduce the adhesion values sufficiently to permit the diced chips to be easily removed. This may occur by blowing hot air across the tape, heated anvil, passing the tape through an infrared zone or hot air oven, etc. The method of heating is not critical, and only need to apply sufficient energy to the tape to thermocure the adhesive to an extent sufficient to reduce or eliminate the adhesive tack of the adhesive so that the chips may be easily removed. Exemplary heating temperatures are generally at least 50° C., and preferably are within the range of 70 to 180° C.

The backing film used in the tape of the present invention is preferably a polymeric film with good heat resistance and expandability. A barrier coat on the backing film may be an advantage to prevent interaction between the adhesive chemistry and the backing film material. Such a barrier can, for example, comprise a polymeric material having good moisture resistance and chemical barrier properties. Examples of such materials include but are not limited to uncrosslinked polymeric coatings such as PVDC (polyvinylidene chloride) and PDVF (polyvinylidene fluoride), as well as crosslinked polymeric coatings (e.g., UV cured multifunctional acrylates and heat seal two-stage adhesives). The thickness of the barriers ranges from 0.1 to 5.0 mils, more preferably 0.3 to 3.0 mils, and most preferably 0.5 to 1.0 mils.

The pressure sensitive adhesive tape of the present invention may take many forms. For example, one side of the adhesive layer may be applied to a backing layer, optionally with a release liner applied to the other side of the adhesive layer. Also, the adhesive layer may be sandwiched between two release liners

The present invention enables many benefits to be achieved, including the following:

(1) The wafer tape has heat release capabilities built into the tape. This reduces backside die damage caused by the typical die ejection method. The die can easily be removed from the tape using a heated anvil or the wafer can simply be subjected to a heated environment. The application of heat eliminates the need for the use of a die ejection system, thus reducing potential die damage considerably.

(2) The adhesion level prior to die release on the wafer tape can be tailored to suit the needs of various manufacturing processes. This is beneficial to dicing the dies of different sizes. The loss of the die during dicing is virtually eliminated. The adhesion level after heating is not dependent on the initial level of adhesion. The reduction of adhesion is permanent.

(3) Unlike with existing heat release tapes which are commercially available, the heat releasable wafer tape of the present invention can be stretchable. This feature allows the tape to be expanded to enhance die removal with minimum damage.

(4) The integrity of the wafer tape construction prevents adhesive transfer to the die.

(5) The cleanliness of the wafer dicing tape prevents contamination or corrosion of the die.

(6) The high clarity of the wafer tape allows vision system detection and alignment.

What is claimed is:

1. A thermocurable pressure sensitive adhesive composition, said composition comprised of at least one pressure sensitive adhesive, at least one multifunctional monomer or oligomer, at least one free radical initiator, and optionally a crosslinking agent.

2. The thermocurable pressure sensitive composition of claim 1, wherein said pressure sensitive adhesive comprises tackified natural rubbers, synthetic rubbers, tackified styrene block copolymers, polyvinyl ethers, acrylic adhesives, poly-alpha-olefins, silicone adhesives, and mixtures thereof.

3. The thermocurable pressure sensitive composition of claim 1, wherein said multifunctional monomer is a difunctional monomer selected from the group consisting of 1,6-diacrylates, 1,4-butanediol diacrylate, ethylene glycol diacrylate, diethylene glycol diacrylate, tetraethylene glycol diacrylate, tripropylene glycol diacrylate, neopentyl glycol diacrylates, 1,4-butanediol dimethyacrylate, hexane diol diacrylate, poly(butanediol)diacrylates, tetraethylene glycol dimethacrylate, 1,3-butylene glycol diacrylate, triethylene glycol diacrylate, triisopropylene glycol diacrylate, polyethylene glycol diacrylate, diallyl maleate, dially phthalate, bisphenol A dimethylacrylate, and mixtures thereof.

4. The thermocurable pressure sensitive adhesive composition of claim 1, wherein said multifunctional monomer is a trifunctional monomer selected from the group consisting of trimethylolpropane triacrylate, trimethylolpropane trimethyacrylate, pentaerythritol monohydroxy triacrylate, trimethylolpropane triethoxy triacrylate, ethoxylated trimethylolpropane triacrylate, pentaerythritol triacrylate, and mixtures thereof.

5. The thermocurable pressure sensitive adhesive composition of claim 1, wherein said multifunctional monomer is a tetrafunctional monomer selected from the group consisting of pentaerythritol tetracrylate, di-trimethylolpropane tetraacrylate, and mixtures thereof.

6. The thermocurable pressure sensitive adhesive composition of claim 1, wherein said multifunctional monomer is a pentafunctional monomer comprising pentaerythritol pentaacrylate.

7. The thermocurable pressure sensitive adhesive composition of claim 1, wherein said adhesive is present in an amount of from 25-90% by weight, said multifunctional monomer or oligomer is present in an amount of from 5-55% by weight, said free radical initiator is present in an amount of from 0.5-10% by weight, and said optional crosslinking agent is present in an amount of up to 5% by weight.

8. The thermocurable pressure sensitive adhesive composition of claim 1, wherein a crosslinking agent is present selected from the group consisting of isocyanates, aziridines, anhydrides, amines, metal chelates, and mixtures thereof.

9. The thermocurable pressure sensitive adhesive composition of claim 1, in the form of a tape comprised of said adhesive composition on a backing layer.

10. The thermocurable pressure sensitive adhesive composition of claim 1, in the form of a tape comprised of said adhesive composition between two release liners.

11. In a method for the production of a semiconductor chip, wherein a wafer chip is attached to a pressure sensitive adhesive layer during the chip manufacturing process during which a diced chip is produced, the improvement wherein said pressure sensitive adhesive is a thermocurable pressure sensitive adhesive composition comprised of at least one pressure sensitive adhesive, at least one multifunctional monomer or oligomer, at least one free radical initiator, and optionally a crosslinking agent, and said adhesive composition is heated to a temperature sufficient to thermocure said adhesive composition subsequent to processing of said diced chip to permit removal of said diced chip from said adhesive.

12. The method of claim 11, wherein said pressure sensitive adhesive comprises tackified natural rubbers, synthetic rubbers, tackified styrene block copolymers, polyvinyl ethers, acrylic adhesives, poly-alpha-olefins, silicone adhesives, and mixtures thereof.

13. The method of claim 11, wherein said multifunctional monomer is a difunctional monomer selected from the group consisting of 1,6-diacrylates, 1,4-butanediol diacrylate, ethylene glycol diacrylate, diethylene glycol diacrylate, tetraethylene glycol diacrylate, tripropylene glycol diacrylate, neopentyl glycol diacrylates, 1,4-butanediol dimethyacrylate, hexane diol diacrylate, poly(butanediol)diacrylates, tetraethylene glycol dimethacrylate, 1,3-butylene glycol diacrylate, triethylene glycol diacrylate, triisopropylene glycol diacrylate, polyethylene glycol diacrylate, diallyl maleate, dially phthalate, bisphenol A dimethylacrylate, and mixtures thereof.

14. The method of claim 11, wherein said multifunctional monomer is a trifunctional monomer selected from the group consisting of trimethylolpropane triacrylate, trimethylolpropane trimethyacrylate, pentaerythritol monohydroxy triacrylate, trimethylolpropane triethoxy triacrylate, ethoxylated trimethylolpropane triacrylate, pentaerythritol triacrylate, and mixtures thereof.

15. The method of claim 11, wherein said multifunctional monomer is a tetrafunctional monomer selected from the group consisting of pentaerythritol tetracrylate, di-trimethylolpropane tetraacrylate, and mixtures thereof.

16. The method of claim 11, wherein multifunctional monomer is a pentafunctional monomer comprised of dipentaerythritol pentaacrylate.

17. The method of claim 11, wherein said adhesive is present in said composition in an amount of from 25-90% by weight, said multifunctional monomer or oligomer is present in an amount of from 5-55% by weight, said free radical initiator is present in an amount of from 0.5-10% by weight, and said optional crosslinking agent is present in an amount of up to 5% by weight.

18. The method of claim 11, wherein a crosslinking agent is present selected from the group consisting of isocyanates, aziridines, anhydrides, amines, metal chelates, and mixtures thereof.

19. The method of claim 11, wherein said adhesive composition is heated to a temperature in the range of from 70 to 180° C.
